(19) United States
(12) Patent Application Publication
(10) Pub. No.: US 2026/0184821 A1
(43) Pub. Date: Jul. 2, 2026

(54) SULFONATED NANOCELLULOSE FILM WITH HIGH PROTON CONDUCTIVITY AND PREPARATION METHOD THEREFOR

(71) Applicant: Shaanxi University of Science and Technology, Xi'an (CN)

(72) Inventors: Sufeng Zhang, Xi'an (CN); Nan Li, Xi'an (CN); Jinrui Li, Xi'an (CN); Qinglu Li, Xi'an (CN); Ning Wei, Xi'an (CN)

(21) Appl. No.: 19/300,827

(22) Filed: Aug. 15, 2025

(30) Foreign Application Priority Data
Dec. 31, 2024 (CN) 2024119941922

(51) Int. Cl. C08B 5/00

(52) U.S. Cl. CPC C08B 5/00

(57) ABSTRACT

A preparation method for a sulfonated nanocellulose film with high proton conductivity includes steps as follows. A dark oxidation reaction is performed on cellulose with sodium periodate by using deionized water as a medium at a pH of 2 to 3 to obtain dialdehyde cellulose. A Schiff base reductive amination reaction is performed on the dialdehyde cellulose, 2-aminoethanesulfonic acid, and 2-methylpyridine borane to obtain a first reacted solution, subsequently, impurities in the first reacted solution are removed to obtain a sulfonated nanocellulose suspension. The sulfonated nanocellulose suspension is shaped into a film by vacuum filtration, and then the film is dried to obtain a sulfonated nanocellulose film with high proton conductivity, which addresses the problems of cellulose, such as low proton conductivity, non-biodegradability, and indirect environmental pollution caused by the preparation process.

### CROSS-REFERENCE TO RELATED APPLICATION

This application claims priority to Chinese Patent Application No. 202411994192.2, filed on Dec. 31, 2024, which is herein incorporated by reference in its entirety.

### TECHNICAL FIELD

The disclosure relates to field of nanocellulose film, and particularly to a sulfonated nanocellulose film with high proton conductivity and a preparation method therefor.

### BACKGROUND

In recent years, stringent requirements for high performance and environmental friendliness of proton exchange membrane fuel cells have triggered intensive improvements in proton exchange membrane materials. Currently, the commonly used perfluorosulfonic acid resin membrane (e.g., Nafion®, Dupont) is limited in its further development due to its poor proton conductivity under low humidity conditions being equal or less than 15 millisiemens/centimeter (mS/cm) at 33% relative humidity (RH), high cost, and non-environmentally friendly material composition (a basic requirement of the proton conductivity is greater than or equal to 100 mS/cm). Therefore, there is an urgent need to develop a new type of proton exchange membrane material to address this problem.

Biomass materials are the best choice for new proton exchange membrane materials. Cellulose, as one of the raw materials for biomass materials, has advantages of abundant raw materials, rapid regeneration, good environmental and biocompatibility, and biodegradability. However, its weak ability to deprotonate surface hydroxyl groups limits its rapid development in this field due to its inability to meet the basic requirement of the proton conductivity.

Based on a polyhydroxyl structure of the cellulose, there have been some reports on improving the proton-conducting carriers within cellulose membranes by introducing high proton-conducting polymers, strong deprotonating sulfonic acid groups, and phosphoric acid groups. Among these methods, the introducing of sulfonic acid groups has been the most prominent in enhancing the proton conductivity. However, there are still many problems in the introduction process: First, sources of sulfonic acid groups being used, such as acrylic acid and sulfosuccinic acid, have complex synthetic processes, certain toxicity, and render the obtained cellulose membranes non-biodegradable. Second, the introducing sulfonic acid groups through hydrogen bonds or dynamic covalent bonds is prone to loss of acidic groups during long-term use, resulting in poor proton conductivity.

### SUMMARY

To solve the problems in the related art, the disclosure provides a sulfonated nanocellulose film with high proton conductivity and a preparation method therefor, aiming to address the problems of cellulose, such as low proton conductivity, non-biodegradability, and indirect environmental pollution caused by the preparation process. The sulfonated nanocellulose film of the disclosure exhibits high proton conductivity.

The technical solutions of the disclosure are as follows.

A preparation method for a sulfonated nanocellulose film with proton conductivity includes steps S1 to S3.

In the step S1, a dark oxidation reaction is performed on cellulose with sodium periodate using deionized water as a medium at potential of hydrogen (pH) in a range of 2 to 3 to obtain dialdehyde cellulose, and a mass ratio of the sodium periodate to the cellulose is in a range of (1.2-1.4):(0.9-1.1).

In the step S2, a Schiff base reductive amination reaction is performed on the dialdehyde cellulose, 2-aminoethanesulfonic acid, and 2-methylpyridine borane with a mass ratio in a range of (0.9-1.1):(2.0-6.0):(0.3-0.33) in deionized water at 59° C. to 65° C. to obtain a first reacted solution, subsequently, impurities in the first reacted solution are removed to obtain a sulfonated nanocellulose suspension.

In the step S3, the sulfonated nanocellulose suspension is shaped into a film by vacuum filtration, and then the film is dried to obtain the sulfonated nanocellulose film with proton conductivity.

In an embodiment, in the step S1, the dark oxidation reaction is performed at 48° C. to 52° C. for 3.0 hours (h) to 3.8 h.

In an embodiment, in the step S1, the cellulose is bleached softwood cellulose.

In an embodiment, in the step S1, the bleached softwood cellulose is uniformly dispersed in the deionized water with a mass ratio of the deionized water to the bleached softwood cellulose in a range of (99-101):(0.9-1.1), the sodium periodate is added into the deionized water dispersed with the bleached softwood cellulose to obtain a mixed solution, the pH of the mixed solution is adjusted by using a 0.1 moles per liter (M) of hydrochloric acid (HCl) solution to 2 to 3, subsequently, the dark oxidation reaction is performed on the adjusted mixed solution to obtain a second reaction solution, and a product in the second reaction solution is washed to obtain the dialdehyde cellulose.

In an embodiment, in the step S1, a wash solution of the deionized water and ethanol is used to wash the product by vacuum filtration until the wash solution after washing the product is neutral, thereby to obtain the dialdehyde cellulose, and deionized water is added into the dialdehyde cellulose with a mass ratio in a range of (0.9-1.1):(9.9-11.1) to obtain a dialdehyde cellulose suspension.

In an embodiment, in the step S2, the 2-aminoethanesulfonic acid and the 2-methylpyridine borane are added into the dialdehyde cellulose suspension to perform the Schiff base reductive amination reaction at 59° C. to 65° C. for 10 h to 13 h to obtain the first reacted solution, subsequently, the impurities in the first reacted solution are removed to obtain the sulfonated nanocellulose suspension.

In an embodiment, un the step S2, the first reaction solution is dialyzed in deionized water for 69 h to 75 h to obtain the sulfonated nanocellulose suspension.

In an embodiment, in the step S3, the sulfonated nanocellulose suspension is shaped into the film on a polyvinylidene difluoride (PVDF) membrane by the vacuum filtration, then the film on the PVDF membrane is dried at 40° C. to 50° C. for 5.5 h to 6.5 h to obtain the sulfonated nanocellulose film with proton conductivity on the PVDF membrane.

In an embodiment, in the step S3, the sulfonated nanocellulose film is exfoliated from the sulfonated nanocellulose film on the PVDF membrane to obtain the sulfonated nanocellulose film with proton conductivity.

The sulfonated nanocellulose film with high proton conductivity is prepared by using the preparation method mentioned above, and a proton conductivity of the sulfonated nanocellulose film is in a range of 44.23 mS/cm to 128.0 mS/cm.

Compared to the related art, the beneficial effects of the disclosure are as follows.

The preparation method for the sulfonated nanocellulose film with high proton conductivity in the disclosure first performs the dark oxidation reaction on cellulose with sodium periodate by using deionized water as a medium under a pH in a range of 2 to 3. By adjusting the mass ratio of the sodium periodate to the cellulose, a pair of adjacent hydroxyl groups in the cellulose molecules are oxidized into aldehyde groups, yielding dialdehyde cellulose. Subsequently, the 2-aminoethanesulfonic acid containing amino and sulfonic acid groups, in combination with the 2-methylpyridine borane as a reducing agent, is used to perform the Schiff base reductive amination reaction on the dialdehyde cellulose. The sulfonic acid groups are smoothly grafted onto the aldehyde groups of the dialdehyde cellulose molecular structure via C—N bonds. After removing the impurities, sulfonated nanocellulose material (i.e. sulfonated nanocellulose suspension) can be obtained. The sulfonation modification of cellulose does not change crystalline form of the cellulose. The nanomorphology exhibited by the sulfonated nanocellulose, with a calculated fiber length of 179.37 nanometers (nm)±28.860 nm (i.e. 179.37 nm with a standard deviation of 28.860 nm) and a fiber width of 8.11±3.21 nm, is achieved. Finally, the sulfonated nanocellulose suspension is shaped into a film by vacuum filtration and then dried to obtain a sulfonated nanocellulose film with high proton conductivity. The preparation method of the disclosure is environmentally friendly and green, and the obtained product is biodegradable. Compared with the original cellulose, the sulfonated nanocellulose film has excellent proton conductivity. Tests show that the proton conductivity of the sulfonated nanocellulose film is in a range of 44.23 mS/cm to 128.0 mS/cm.

### BRIEF DESCRIPTION OF DRAWINGS

FIG. 1 illustrates a Fourier transform infrared spectroscopy (FTIR) diagram of dialdehyde cellulose, sulfonated nanocellulose, and an original pulp (Pulp) obtained in embodiments 1-3 of the disclosure.

FIG. 2 illustrates an X-ray diffraction (XRD) diagram of the sulfonated nanocellulose, and the Pulp obtained in the embodiments 1-3 of the disclosure.

FIG. 3 illustrates an X-ray photoelectron spectroscopy (XPS) diagram of the sulfonated nanocellulose, and the Pulp obtained in the embodiments 1-3 of the disclosure.

FIG. 4 illustrates a transmission electron microscopy (TEM) diagram of the sulfonated nanocellulose obtained in the embodiment 3 of the disclosure.

FIG. 5A illustrates a change diagram of proton conductivity with temperature and relative humidity (RH, 33% RH) of the sulfonated nanocellulose obtained in obtained in the embodiments 1-3 of the disclosure and a perfluorosulfonic acid resin membrane.

FIG. 5B illustrates a change diagram of proton conductivity with temperature and RH (98% RH) of the sulfonated nanocellulose obtained in obtained in the embodiments 1-3 of the disclosure and a perfluorosulfonic acid resin membrane.

FIG. 6 illustrates a reaction equation with chemical structures of a preparation method for the sulfonated nanocellulose in the disclosure.

### DETAILED DESCRIPTION OF EMBODIMENTS

The following provides a further detailed explanation of the disclosure through specific embodiments, which is an explanation of the disclosure rather than a limitation.

A preparation method for a sulfonated nanocellulose film with high proton conductivity includes steps as follows.

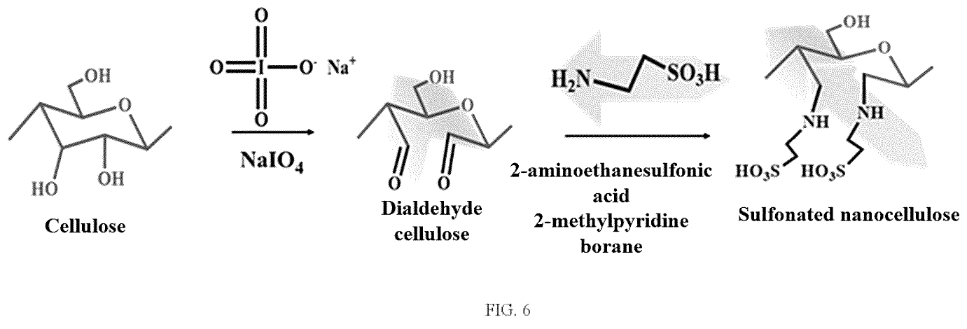

In the step 1, 0.9-1.1 parts by weight of bleached softwood cellulose are weighed, and 99-101 parts by weight of deionized water are measured. After the bleached softwood cellulose is fully dispersed in the deionized water, 1.2-1.4 parts by weight of sodium periodate are added in the deionized water dispersed with the bleached softwood cellulose, a pH of the deionized water dispersed with the bleached softwood cellulose and added with the sodium periodate is adjusted to 2-3 with 0.1 M HCl solution, and the dark oxidation reaction illustrated in FIG. 6 is carried out at 48° C. to 52° C. for 3.0 h to 3.8 h to obtain a reaction solution with product. The product is then washed with deionized water and ethanol under vacuum filtration until the deionized water and ethanol washed the product is neutral, thereby to obtain a dialdehyde cellulose solid with low moisture content, designated as DAC. Subsequently, 9.9-11.1 parts by weight of deionized water are added into the DAC to obtain a dialdehyde cellulose suspension, i.e., the dialdehyde cellulose suspension containing oven-dry dialdehyde cellulose.

In the step 2, the dialdehyde cellulose suspension containing 0.9-1.1 parts by weight of oven-dry dialdehyde cellulose, 2.0-6.0 parts by weight of 2-aminoethanesulfonic acid, and 0.3-0.33 parts by weight of 2-methylpyridine borane are weighed, and the Schiff base reductive amination reaction illustrated in FIG. 6 is performed at 59° C. to 65° C. for 10 h to 13 h. After dialysis in deionized water for 69 h to 75 h, a sulfonated nanocellulose suspension is obtained, then the sulfonated nanocellulose suspension is shape into a sulfonated nanocellulose film on a PVDF membrane via vacuum filtration and dried at 40° C. to 50° C. for 5.5 h to 6.5 h, thereby to obtain the sulfonated nanocellulose (SNC) membrane.

An internal impedance of the sulfonated nanocellulose film is characterized by electrochemical impedance spectroscopy under specified temperature and humidity conditions, and the proton conductivity value is calculated from the impedance. Testing shows that the proton conductivity of the sulfonated nanocellulose film is in a range of 44.23 mS/cm to 128.0 mS/cm.

### Embodiment 1

A preparation method for a sulfonated nanocellulose film with high proton conductivity includes steps as follows.

In the step 1, 1 part by weight of bleached softwood cellulose are weighed, and 100 parts by weight of deionized water are measured. After the bleached softwood cellulose is fully dispersed in the deionized water, 1.3 parts by weight of sodium periodate are added in the deionized water dispersed with the bleached softwood cellulose, a pH of the deionized water dispersed with the bleached softwood cellulose and added with the sodium periodate is adjusted to 2 with 0.1 M HCl solution, and the dark oxidation reaction is carried out at 48° C. for 3.5 h to obtain a reaction solution with a product. The product is then washed with deionized water and ethanol under vacuum filtration until the deionized water and ethanol washed the product is neutral, thereby to obtain a dialdehyde cellulose solid with low moisture content, designated as DAC. Subsequently, 10 parts by weight of deionized water are added into the DAC to obtain a dialdehyde cellulose suspension.

In the step 2, the dialdehyde cellulose suspension containing 1 part by weight of oven-dry dialdehyde cellulose, 2 parts by weight of 2-aminoethanesulfonic acid, and 0.3 parts by weight of 2-methylpyridine borane are weighed, and the Schiff base reductive amination reaction is performed at 60° C. for 12 h. After dialysis in deionized water for 72 h, a sulfonated nanocellulose suspension is obtained, then the sulfonated nanocellulose suspension is shape into a sulfonated nanocellulose film on a PVDF membrane via vacuum filtration and dried at 45° C. for 6 h, thereby to obtain the sulfonated nanocellulose (SNC-2) membrane.

The obtained sulfonated nanocellulose film exhibits a proton conductivity of 61.10 mS/cm at 80° C. and 98% RH.

### Embodiment 2

A preparation method for a sulfonated nanocellulose film with high proton conductivity includes steps as follows.

In the step 1, 1 part by weight of bleached softwood cellulose are weighed, and 100 parts by weight of deionized water are measured. After the bleached softwood cellulose is fully dispersed in the deionized water, 1.3 parts by weight of sodium periodate are added in the deionized water dispersed with the bleached softwood cellulose, a pH of the deionized water dispersed with the bleached softwood cellulose and added with the sodium periodate is adjusted to 2 with 0.1 M HCl solution, and the dark oxidation reaction is carried out at 50° C. for 3.5 h to obtain a reaction solution with a product. The product is then washed with deionized water and ethanol under vacuum filtration until the deionized water and ethanol washed the product is neutral, thereby to obtain a dialdehyde cellulose solid with low moisture content, designated as DAC. Subsequently, 10 parts by weight of deionized water are added into the DAC to obtain a dialdehyde cellulose suspension.

In the step 2, the dialdehyde cellulose suspension containing 1 part by weight of oven-dry dialdehyde cellulose, 4 parts by weight of 2-aminoethanesulfonic acid, and 0.3 parts by weight of 2-methylpyridine borane are weighed, and the Schiff base reductive amination reaction is performed at 60° C. for 12 h. After dialysis in deionized water for 72 h, a sulfonated nanocellulose suspension is obtained, then the sulfonated nanocellulose suspension is shape into a sulfonated nanocellulose film on a PVDF membrane via vacuum filtration and dried at 40° C. for 6.5 h, thereby to obtain the sulfonated nanocellulose (SNC-4) membrane.

The obtained sulfonated nanocellulose film exhibits a proton conductivity of 96.77 mS/cm at 80° C. and 98% RH.

### Embodiment 3

A preparation method for a sulfonated nanocellulose film with high proton conductivity includes steps as follows.

In the step 1, 1 part by weight of bleached softwood cellulose are weighed, and 100 parts by weight of deionized water are measured. After the bleached softwood cellulose is fully dispersed in the deionized water, 1.3 parts by weight of sodium periodate are added in the deionized water dispersed with the bleached softwood cellulose, a pH of the deionized water dispersed with the bleached softwood cellulose and added with the sodium periodate is adjusted to 2 with 0.1 M HCl solution, and the dark oxidation reaction is carried out at 52° C. for 3.5 h to obtain a reaction solution with a product. The product is then washed with deionized water and ethanol under vacuum filtration until the deionized water and ethanol washed the product is neutral, thereby to obtain a dialdehyde cellulose solid with low moisture content, designated as DAC. Subsequently, 10 parts by weight of deionized water are added into the DAC to obtain a dialdehyde cellulose suspension.

In the step 2, the dialdehyde cellulose suspension containing 1 part by weight of oven-dry dialdehyde cellulose, 6 parts by weight of 2-aminoethanesulfonic acid, and 0.3 parts by weight of 2-methylpyridine borane are weighed, and the Schiff base reductive amination reaction is performed at 60° C. for 12 h. After dialysis in deionized water for 72 h, a sulfonated nanocellulose suspension is obtained, then the sulfonated nanocellulose suspension is shape into a sulfonated nanocellulose film on a PVDF membrane via vacuum filtration and dried at 50° C. for 5.5 h, thereby to obtain the sulfonated nanocellulose (SNC-6) membrane.

The obtained sulfonated nanocellulose film exhibits a proton conductivity of 128.0 mS/cm at 80° C. and 98% RH, and a proton conductivity of 44.23 mS/cm at 80° C. and 33% RH.

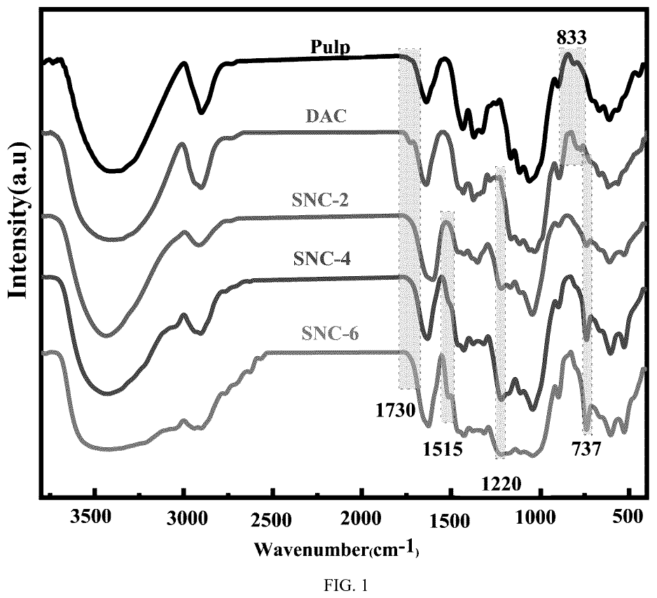

The FTIR diagram in FIG. 1 reveals the changes in the chemical structure of sulfonated nanocellulose compared with the Pulp. After sulfonation, characteristic absorption peaks at 1515 cm⁻¹ (C═N), 1220 cm⁻¹ (S═O), and 737 cm⁻¹ (S—O) appear, confirming that sulfonic acid groups are successfully grafted onto the cellulose molecular structure.

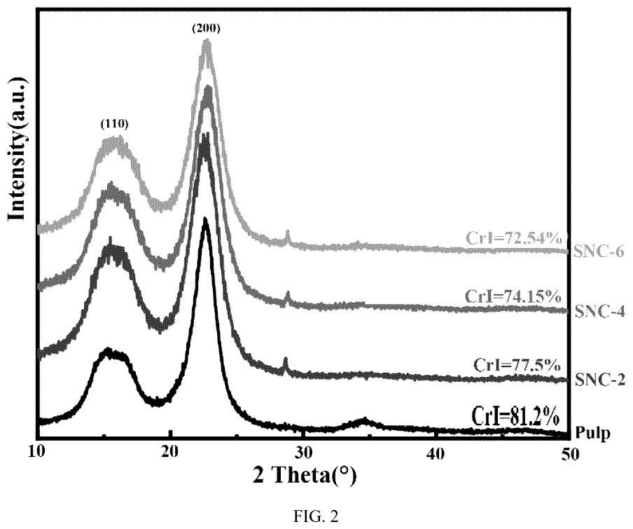

The XRD diagram in FIG. 2 shows the crystalline structure variation between sulfonated nanocellulose and the original cellulose. Both modified and unmodified cellulose exhibit three main diffraction peaks at 2θ with 15°, 17°, and 23°, characteristic of cellulose I, indicating that the sulfonation modification does not change the crystalline form of cellulose.

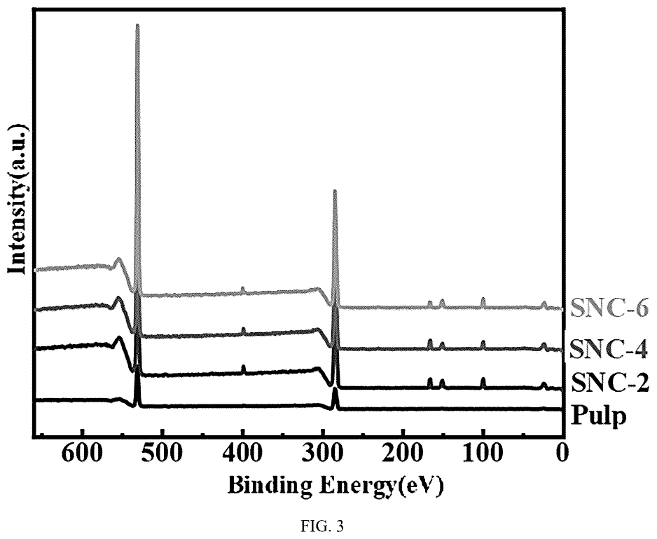

The XPS diagram in FIG. 3 demonstrates the presence of nitrogen and sulfur in the modified cellulose structure, verifying the successful preparation of sulfonated nanocellulose.

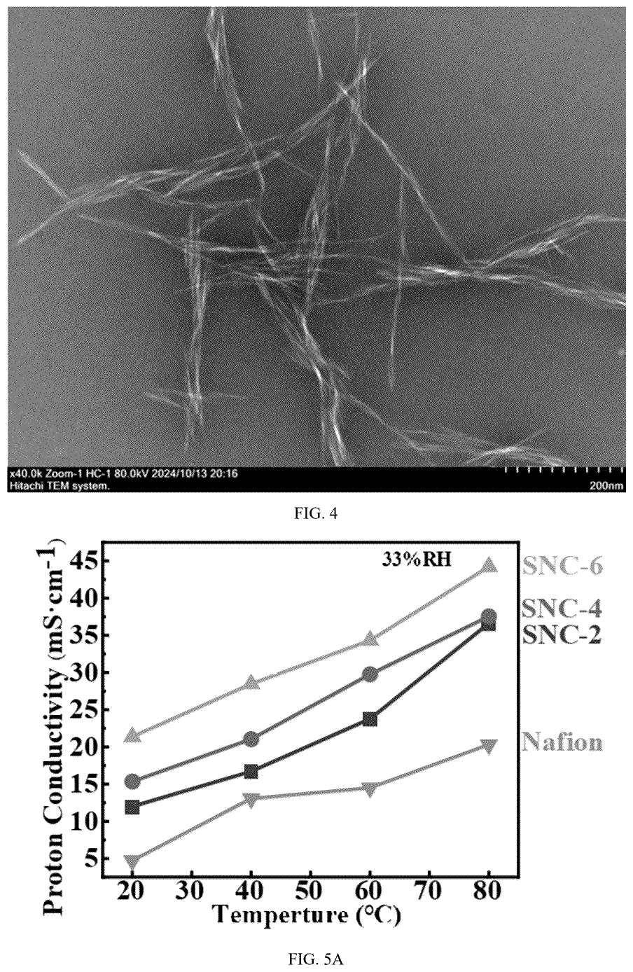

The TEM diagram in FIG. 4 reveals the nanomorphology of the sulfonated nanocellulose film. Calculated particle dimensions give a fiber length of 179.37 nm±28.86 nm and a fiber width of 8.11 nm±3.21 nm.

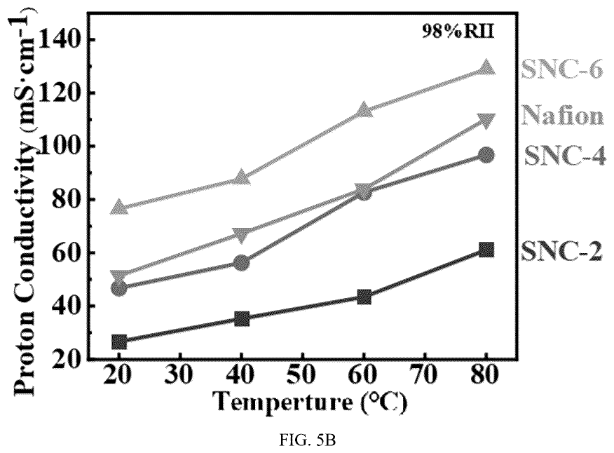

FIGS. 5A and 5B display the proton conductivity changes of the sulfonated nanocellulose films obtained in the embodiments 1-3 and the perfluorosulfonic acid resin membrane at 33% RH and 98% RH, respectively. Under 33% RH, all sulfonated nanocellulose films exhibit higher proton conductivity than the perfluorosulfonic acid resin membrane. For both the sulfonated nanocellulose films and the perfluorosulfonic acid resin membrane, proton conductivity increases with humidity. The sulfonated nanocellulose film reaches 128.0 mS/cm at 98% RH and 80° C., demonstrating high proton conductivity.

What is claimed is:

1. A preparation method for a sulfonated nanocellulose film with proton conductivity, comprising:
S1, performing, using deionized water as a medium, a dark oxidation reaction on cellulose with sodium periodate at a potential of hydrogen (pH) in a range of 2 to 3 to obtain dialdehyde cellulose, wherein a mass ratio of the sodium periodate to the cellulose is in a range of (1.2-1.4):(0.9-1.1);
S2, performing a Schiff base reductive amination reaction on the dialdehyde cellulose, 2-aminoethanesulfonic acid, and 2-methylpyridine borane with a mass ratio in a range of (0.9-1.1):(2.0-6.0):(0.3-0.33) in deionized water at 59° C. to 65° C. to obtain a first reacted solution, subsequently, removing impurities in the first reacted solution to obtain a sulfonated nanocellulose suspension;
S3, shaping the sulfonated nanocellulose suspension into a film by vacuum filtration, and then drying the film to obtain the sulfonated nanocellulose film with proton conductivity.

2. The preparation method for the sulfonated nanocellulose film with proton conductivity as claimed in claim 1, wherein in the step S1, the dark oxidation reaction is performed at 48° C. to 52° C. for 3.0 hours (h) to 3.8 h.

3. The preparation method for the sulfonated nanocellulose film with proton conductivity as claimed in claim 1, wherein in the step S1, the cellulose is bleached softwood cellulose.

4. The preparation method for the sulfonated nanocellulose film with proton conductivity as claimed in claim 3, wherein the step S1 comprises:
uniformly dispersing the bleached softwood cellulose in the deionized water with a mass ratio of the deionized water to the bleached softwood cellulose in a range of (99-101):(0.9-1.1), adding the sodium periodate into the deionized water dispersed with the bleached softwood cellulose to obtain a mixed solution, adjusting, using a 0.1 moles per liter (M) of hydrochloric acid (HCl) solution, the pH of the mixed solution to 2 to 3, subsequently performing the dark oxidation reaction on the adjusted mixed solution to obtain a second reaction solution, and washing a product in the second reaction solution to obtain the dialdehyde cellulose.

5. The preparation method for the sulfonated nanocellulose film with proton conductivity as claimed in claim 4, wherein the step S1 comprises:
washing, using a wash solution of the deionized water and ethanol, the product by vacuum filtration until the wash solution after washing the product is neutral, thereby to obtain the dialdehyde cellulose; adding deionized water into the dialdehyde cellulose with a mass ratio in a range of (0.9-1.1):(9.9-11.1) to obtain a dialdehyde cellulose suspension.

6. The preparation method for the sulfonated nanocellulose film with proton conductivity as claimed in claim 5, wherein the step S2 comprises:
adding the 2-aminoethanesulfonic acid and the 2-methylpyridine borane into the dialdehyde cellulose suspension to perform the Schiff base reductive amination reaction at 59° C. to 65° C. for 10 h to 13 h to obtain the first reacted solution, subsequently, removing the impurities in the first reacted solution to obtain the sulfonated nanocellulose suspension.

7. The preparation method for the sulfonated nanocellulose film with proton conductivity as claimed in claim 6, wherein the step S2 comprises:
dialyzing the first reaction solution in deionized water for 69 h to 75 h to obtain the sulfonated nanocellulose suspension.

8. The preparation method for the sulfonated nanocellulose film with proton conductivity as claimed in claim 1, wherein the step S3 comprises:
shaping the sulfonated nanocellulose suspension is into the film on a polyvinylidene difluoride (PVDF) membrane by the vacuum filtration, then drying the film on the PVDF membrane at 40 ° C. to 50 ° C. for 5.5 h to 6.5 h to obtain the sulfonated nanocellulose film with proton conductivity on the PVDF membrane.

9. The preparation method for the sulfonated nanocellulose film with proton conductivity as claimed in claim 8, wherein the step S3 comprises:
exfoliating the sulfonated nanocellulose film from the sulfonated nanocellulose film on the PVDF membrane to obtain the sulfonated nanocellulose film with proton conductivity.

10. The sulfonated nanocellulose film with proton conductivity, prepared by using the preparation method as claimed in claim 1.
